(19) United States
(12) Patent Application Publication
(10) Pub. No.: US 2016/0012742 A1
(43) Pub. Date: Jan. 14, 2016

(54) APPARATUS FOR PROVIDING GAME INTERWORKING WITH ELECTRONIC BOOK

(71) Applicant: WEDU COMMUNICATION CO., LTD., Mapo-gu Seoul (KR)

(72) Inventor: Kyu Ha Lee, Goyang (KR)

(21) Appl. No.: 14/770,548

(22) PCT Filed: Feb. 27, 2014
(86) PCT No.: PCT/KR2014/001615

§ 371 Date: Aug. 26, 2015

(30) Foreign Application Priority Data
Feb. 27, 2013 (KR) 10-2013-0020973
Apr. 10, 2013 (KR) 10-2013-0039090

(51) Int. Cl. G09B 7/00; A63F 13/798; G06F 3/0484; A63F 13/67; A63F 13/80; H04L 29/08; A63F 9/24; A63F 13/95

(52) U.S. Cl. CPC G09B 7/00; A63F 9/24; A63F 13/798; A63F 13/95; A63F 13/67; A63F 13/80; H04L 67/22; G06F 3/04842; A63F 2009/2457

(57) ABSTRACT

An apparatus for providing a game interworking with an electronic book is disclosed. The apparatus receives from the electronic book, which is executed separately from the game, the result of reading tracking collected while the electronic book is played, converts same using a metadata system, and then determines a learning asset and game content to be provided during game play using same. The present invention is configured such that when playing the game according to the present invention after reading a known electronic book, which is completely separate from the present invention, a user can play game content corresponding to the read content of the electronic book, or the level of understanding or degree of interest through the reading. Accordingly, the user can learn by experience principles or knowledge, which has been acquired by reading the electronic book, by repetition through the game during the game play.

### TECHNICAL FIELD

The present invention disclosed herein relates to an edutainment technology field.

### BACKGROUND ART

Recently, a classic type of books is being gradually digitalized.

The form of learning is also changing due to the change of these media. In the past, students learned by listening to the lecture of lecturers or teachers in a lecture room or classroom. Recently, as the e-learning technology is developed, students can learn by viewing video lecture while using learning contents provided in a web environment.

However, while e-learning overcomes time and space constraints, there is a limitation in that a leaner needs to learn while viewing a video alone. Accordingly, when having a weak will, a leaner may easily lose interest or be bored.

For this reason, it is difficult to completely substitute off-line class in a classroom or lecture room with e-learning.

Meanwhile, lecture and teaching behaviors that are being performed off-line are expected to further evolve by the medium of electronic type of books.

That is, a learner experiences as if the learner reads a classic type of books by storing an electronic book in a terminal and playing the electronic book on a screen, and a lecturer also gives a lecture using the electronic book.

In this case, various advantages of the electronic type of books that are connected to each other through a network may be actively utilized in teaching behaviors.

Meanwhile, edutainment, which is a compound word of education and entertainment, refers to an educational form that enables interesting learning as if enjoying games.

That is, edutainment has an advantage in that the learning motives can be enhanced or aroused by allowing a learner to learn while playing game through contents with amusement.

The effect of edutainment service or contents can be maximized when organically combined in a learning process.

However, the edutainment service and the edutainment contents simply provide learning contents by implication during playing of game, or merely allow a learner to play a game in reward for learning activity.

Accordingly, a study on organic combination with a space in which learning is performed is needed.

Particularly, as the learning media are expected to evolve into the electronic type of books, the development of a new methodology for interworking with existing electronic books and allowing a user to learn by repeating knowledge or learning principle acquired from electronic books through a game is needed.

### DISCLOSURE

### Technical Problem

The present invention provides a method for interworking an existing electronic book and game, which allows a user who reads an electronic book to learn knowledges or learning principles acquired from reading through repeated game plays when playing a game completely different from the electronic book.

The present invention also provides an apparatus of providing a game interworking with an electronic book, which can interwork with the content of game play regardless of the type of electronic book by converting the result of reading tracking acquired from the electronic book completely different from the game or a viewer of the electronic book using a metadata system.

### Technical Solution

In one general aspect, an apparatus of providing a game interworking with an electronic book, the apparatus including a terminal device playing the electronic book to display the electronic book on a display device and playing the game to display on the display device in accordance with a user input through a user interface device, the apparatus includes: an electronic book communication unit receiving a tracking result of a reading behavior of a user acquired during the play of the electronic book from the electronic book; a metadata storage unit storing a metadata system; a metadata converting unit converting the tracking result of the reading behavior of a user received using the metadata system; a game contents storage unit storing game contents; and a game executing unit executing the game in accordance with manipulation of a user, selecting game contents to be executed in the game, using the tracking result of the reading behavior of a user, and executing the game contents that are selected, wherein the metadata system stored in the metadata storage unit includes a metadata item about a learning theme, and the metadata converting unit selects a learning theme metadata item related to the electronic book that a user reads from the received tracking result of the reading behavior of a user.

Other features and aspects will be apparent from the following detailed description, the drawings, and the claims.

### Advantageous Effects

According to the embodiment of the present invention, an electronic book can interwork with a game by converting a tracking result on a reading behavior of the existing electronic book completely different from the game using a metadata system.

Particularly, an electronic book and a game can easily interwork with each other regardless of the type of the electronic books. Furthermore, when the electronic book or a viewer of the electronic book provides a unit for using an existing tracking result in a reading behavior in future, it is possible to return a tracking result of the game play process to the electronic book or the viewer of the electronic book. That is, the tracking result of the game play can be utilized like a tracking result on an existing reading behavior.

Thus, by interworking the game and the electronic book, a user can strengthen the degree of understanding by repeating knowledges or learning principles acquired from a reading behavior through game play.

Furthermore, a learning effect can be maximized by converting learned knowledge acquired through a repetitive game play into a long-term memory.

### DESCRIPTION OF DRAWINGS

FIG. 1 is a view illustrating an electronic book and a game executed in a terminal device;

FIG. 2 is a view illustrating a conceptual metadata system;

FIG. 3 is a view illustrating a process of interworking an electronic book and a game by converting a tracking result received from the electronic book;

FIG. 4 is a view illustrating a connection relationship between a terminal device and servers through network; and

FIG. 5 is a view illustrating the configuration of an apparatus of providing a game interworking with an electronic book.

### BEST MODE

Hereinafter, exemplary embodiments of the present invention will be described in detail with reference to the accompanying drawings. In order to clarify the present invention, a description irrelevant to the constitution of the present invention will be omitted, and in the drawings, like reference numerals refer to like elements throughout.

Since the terms “including”, “comprising”, and “having” can be construed as encompassing corresponding components unless specially described as opposite, it should be understood that they do not exclude other components but encompass other components. Unless defined otherwise, all technical and scientific terms have the same meanings as commonly understood by those skilled in the art to which the present invention belongs.

In the detailed description of the invention and claims, components named as “˜unit”, “˜part”, “˜module”, and “˜block” mean units that process at least one function or operation, and each of which can be implemented by software, hardware, or a combination thereof.

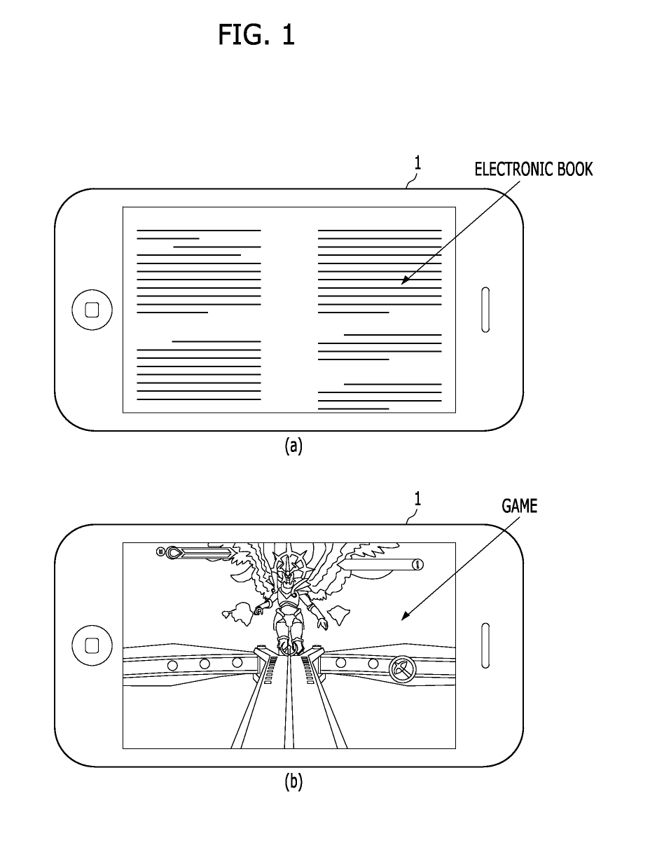

FIG. 1 is a view illustrating an electronic book and a game executed in a terminal device.

The terminal device 1 may execute an electronic book and a game.

For this, the terminal device 1 may include a user interface device for an input of a user. The user interface device may include a mouse, a keyboard, and a touchscreen.

Meanwhile, the terminal device 1 may include a display device to display the electronic book or the game which is executed. For example, the display device may include an LCD or LED screen.

The terminal device 1 may play various electronic books regardless of the game illustrated in FIG. 1.

The electronic book as shown in FIG. 1 may include multimedia contents, which are configured in accordance with a certain order including text, image, and sound.

A user may understand the story and content included in an electronic book by watching and hearing multimedia contents with eyes and ears. That is, this may correspond to a classic type of reading behavior.

Meanwhile, a viewer may be mounted onto the terminal device 1 to play the electronic book. Thus, the electronic book may be played, and the reading process of the electronic book may be tracked. The viewer may be an application program basically supporting the operating system, or may be an application program which is separately installed.

The present invention relates to a method of interworking an electronic book and a game by receiving a tracking result of the reading process from the electronic book or the viewer of the electronic book and converting the tracking result. Tracking of the electronic book itself does not pertain to the scope of the present invention.

That is, as known in the e-learning technology field, when a user reads an electronic book, it may be assumed that the electronic book itself or the viewer of the electronic book tracks a series of the reading processes of a user.

When a user plays the game using the terminal device 1, the tracking result on the reading process of a user may be delivered as a factor during the execution of the game.

For example, when there is an operation of a user, the viewer of the electronic book may finish the play of the electronic book, and may execute the game by calling the game using API provided in the game. In this case, the tracking result may be delivered to API as a factor.

Alternatively, the terminal device 1 may separately store the tracking result of the electronic book, and then may deliver the tracking result as a factor when the game is executed.

That is, in this embodiment, it may be assumed that regardless of the execution of the game, a user reads the electronic book prior to the execution of the game and the tracking result on the reading process is delivered upon execution of the game.

As shown in FIG. 1, the game may be executed in the terminal device 1, and may not be limited in genre and form thereof. That is, the game may be game software executed in platforms of computers, home consoles, and smartphones.

However, the game according to the embodiment may be a space that does not include only amusing elements but also includes learning elements.

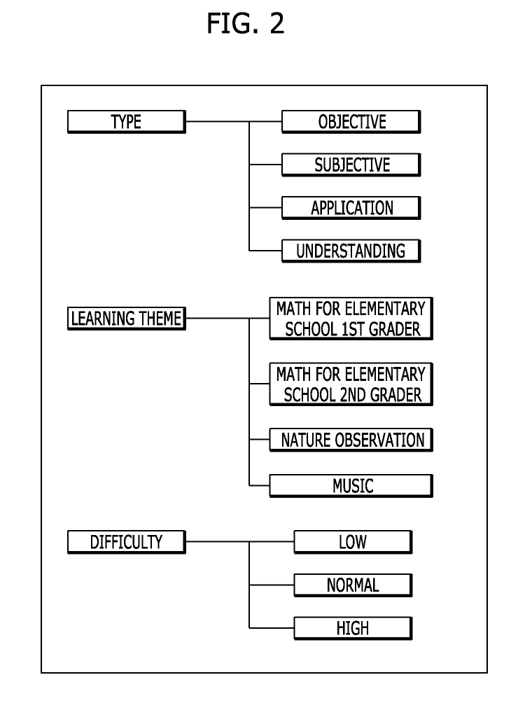

FIG. 2 is a view illustrating a metadata system.

The metadata system may include “learning theme” metadata item.

As described later, each item of metadata may be applied to the learning asset or the game contents. The “learning theme” metadata item may be used to indicate which learning contents the learning assets or the game contents relate to.

The “learning theme” metadata may have a text type of value such that a specific content can be identified. For example, the “learning theme” metadata may have a value “number π”.

Alternatively, the “learning theme” metadata item may be more elaborately configured so as to have a plurality of layers. For example, “learning theme” metadata may include a hierarchical value like “math for elementary school-sixth grader-first semester-chapter 3-number π”.

The “learning theme” metadata item may be for identifying the learning content that the learning assets and the game contents relate to, and may also have a form of unique identifier in which characters or numerals are arranged.

Meanwhile, “type” metadata item may be used to classify the types of the learning assets or the game contents.

The “type” metadata item may be classified into some types such as “subjective”, “objective”, “applied problem”, and “improving comprehension” in accordance with criteria by which the types are classified.

Meanwhile, the “difficulty” metadata item may be used to indicate the degree of difficulty of the learning content related to the learning assets or the game contents. For example, the “difficulty” metadata item may include values such as “low”, “normal”, and “high”.

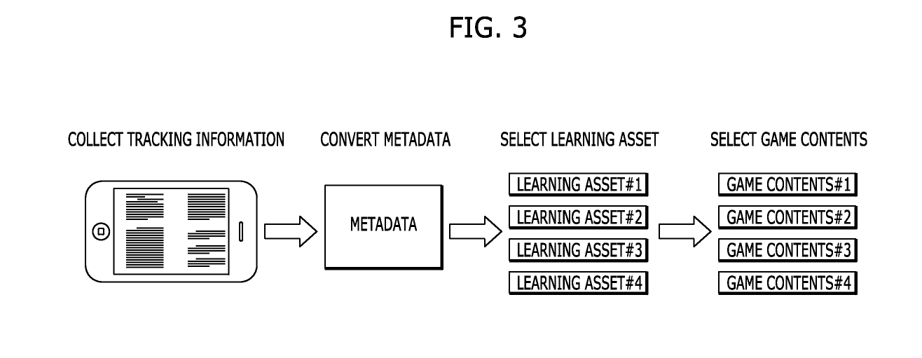

FIG. 3 illustrates a process of converting the tracking result of the reading behavior provided from the electronic book through metadata to select the learning asset and selecting the game contents to which the learning asset is applied to be expressed.

As shown in FIG. 3, first, when the tracking result of the reading behavior is provided from the electronic book (hereinafter, it will be assumed that the tracking result is also provided from the “viewer of electronic book”.), the terminal device 1 may select appropriate metadata items (or item values thereof) from the received tracking result using the metadata system as shown in FIG. 2.

Also, the learning asset may be selected using the selected metadata item, and the game contents to which the selected learning asset is to be applied may be selected.

The learning asset may denote unit elements prepared so as to reflect learning elements in the game contents.

For example,

“Question of NPC: How long is the circumference of a circle with a radius of 1 cm?”,

“Right answer: 6.24 cm”,

“Reply of NPC to right answer: Correct”,

“Typical wrong answer: 3.14 cm”,

“Reply of NPC to typical wrong answer: You are mixing up radius with diameter”,

“Reply of NPC to other wrong answers: Think again”.

As above, the learning asset may be data including values about some items which can be reflected in the game, e.g., question of NPC, answer, reply of NPC to right answer, typical wrong answer, reply of NPC to typical wrong answer, and reply of NPC to other wrong answers.

If necessary, the learning asset may further include multimedia contents in addition to text.

Meanwhile, the learning asset may not be reflected in all game contents.

For example, the learning asset can be reflected in game contents of “subjective quiz” type in which a user needs to meet NPC and input an answer, but is difficult to apply to the “application” or “objective quiz” type.

Accordingly, each learning asset may have applicable “type” metadata.

The learning asset can be applied to game contents having the same “type” metadata as its own “type” metadata.

Meanwhile, each learning asset may include “learning theme” metadata.

For example, “learning theme” metadata of the learning asset described above may have a value “number π”.

Also, “learning theme” metadata may include a value like “math for elementary school-sixth grader-first semester-chapter 3-number π”.

Meanwhile, the game may include a plurality of learning assets having the same “learning theme” metadata.

The game contents may mean one of various content elements configuring the game.

For example, in case of adventure game, the game contents may indicate a specific space on game world map, and in case of RPG game, may also indicate a specific quest or mission.

That is, the game contents may denote a unit that can be differentiated in terms of content from the whole game contents.

In this case, each game contents may have conditions (clear conditions) by which the corresponding game contents can be successfully played.

Meanwhile, the game contents may have “type” metadata, and may be contents of template type to which the learning asset can be applied.

That is, as described in the above example, some items like question of NPC, answer, reply of NPC to right answer, typical wrong answer, reply of NPC to typical wrong answer, and reply of NPC to other wrong answers may be set as variables. When a variable is designated, the corresponding item may be executed by reflecting the variable.

For example, if game contents can be cleared only when a user meets and answers a Non-Player Character (NPC), the game contents may be a “subjective quiz” type. On the other hand, if game contents can be cleared by selecting one of some choice alternatives, the game contents may be an “objective quiz” type.

In addition, in case of game contents in which a specific motion needs to be performed base on understanding about knowledge or a user needs to move along a specific motion line, the game contents may be “application” or “understanding” type.

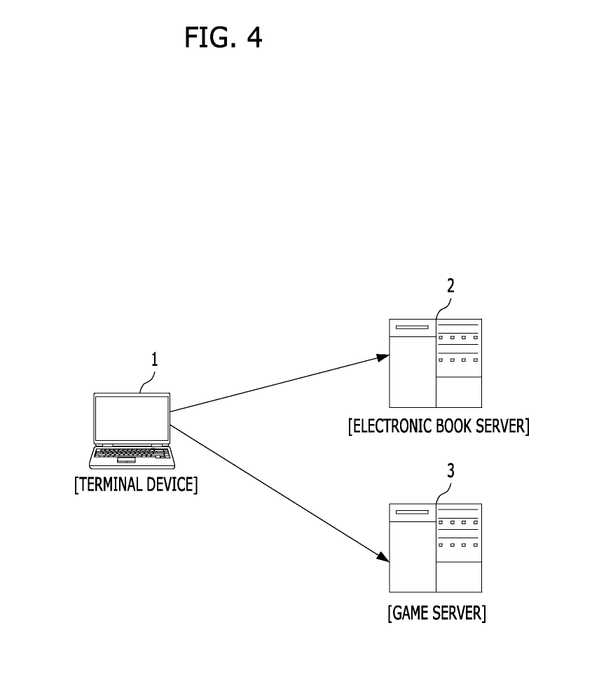

FIG. 4 is a view illustrating a connection structure between a terminal device 1 and servers through network.

The terminal device 1 may further include a wired/wireless communication adapter for accessing the server through the network. For example, the terminal device 1 may include a personal desktop computer, a laptop, a smartphone, and a tablet.

Meanwhile, the electronic book server 2 may provide electronic book data by a downloading or streaming method for the terminal device 1 connected through the network. Alternatively, the electronic book server 2 may collect the tracking information on the reading behavior of the electronic book to provide the tracking information for the terminal device 1.

That is, the present invention is not limited to a case where the terminal device 1 performs tracking by itself, and does not exclude tracking by the electronic book server 2.

Meanwhile, the game server 3 may provide game data by a downloading or streaming method for the terminal device 1 connected through the network, or may provide various kinds of data services for the execution of the game. Furthermore, the game server 3 may also collect and track the game play behaviors.

The learning contents server 4 may include learning contents about each learning theme. The learning contents may be a short video clip related to a specific learning theme.

For example, the learning contents may be audiovisual materials explaining the learning theme, or may be a lecture video of a lecturer about the learning theme.

The learning contents server 4 may provide learning contents about a specific learning theme in real-time when there is a request of the terminal device 1. The learning contents server 4 may provide data of video clip by a streaming method.

Meanwhile, the electronic book server 2, the game server 3, and the learning contents server 4 have been described as separate components, but may be mounted in or implemented in single server hardware or may be implemented in a plurality of server farms or groups.

The edutainment system 100 may be implemented in the terminal device 1 connected to the electronic book server 2, the game server 3, and the learning contents server 4 through the network.

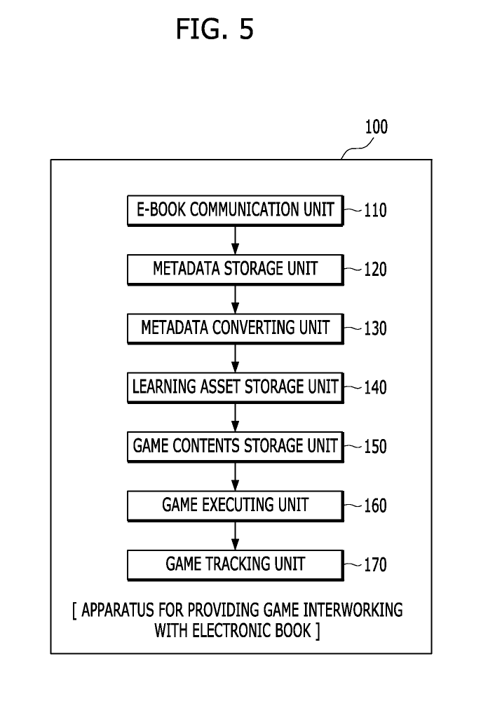

FIG. 5 is a view illustrating the configuration of an apparatus 100 of providing a game interworking with an electronic book.

As shown in FIG. 5, the apparatus 100 of providing the game interworking with the electronic book may include an electronic book communication unit 110, a metadata storage unit 120, a metadata converting unit 130, a learning asset storage unit 140, a game contents storage unit 150, a game executing unit 160, and a game tracking unit 170.

The electronic book communication unit 110 may receive the tracking result of the reading behavior of a user acquired during the play of the electronic book from the electronic book.

In this case, since the electronic book itself exists as data instead of an application of an executable form, the term, the electronic book can be construed as meaning a dedicated viewer for playing the electronic book.

Meanwhile, the metadata storage unit 120 may store the metadata system as shown in FIG. 2.

The metadata converting unit 130 may convert the tracking result of the reading behavior of a user received using the metadata system.

The metadata converting unit 130 may select a learning theme metadata item related to the electronic book that a user has read from the received tracking result of the reading behavior of a user.

Specifically, the metadata conversion process may be performed as follows.

First, the received tracking result of the reading behavior of a user may include one or more pieces of information on type, frequency and duration time of an interaction of a user in regard to corresponding contents and identification information on contents included in the electronic book.

That is, it is based on the premise that the present invention is provided with such tracking result.

The metadata converting unit 130 may select identification information of one content, by multiplying the type, frequency, or duration time of the interaction of a user collected for each identification information of contents included in the electronic book by a certain weighted value.

While a user is reading the electronic book, the interaction of a user may include various types such as turning pages and repeated play in addition to simple operations like simple clicking or dragging. Also, weighted values may be assigned to each type of interaction to determine whether a user is interested in specific contents, whether a user understands the specific contents, and whether a user turns pages while speed-reading the electronic book.

Consequently, it may be determined which contents a user has mainly learned through the reading process or which contents a user needs to repeatedly learn.

A detailed algorithm may differ in accordance with a combination of the type or attribute of the interaction and the weighted value. However, for example, weighted values may be assigned for each type of interaction of a user. In this case, contents in which a value obtained by multiplying the frequency of interaction of a user by the weighted value or multiplying the duration time of interaction of a user by the weighted value is determined as the largest may be selected.

Through such algorithm, for example, contents on which a user has spent most time and has shown interest may be selected.

Also, the metadata converting unit 130 may select a learning theme item corresponding to identification information of the selected contents from metadata.

For example, when the identification information of the selected contents includes a text type of data, “first semester math for elementary school first grader”, a learning theme closest thereto may be selected from the metadata system. These series of processes may be performed by extracting keywords through parsing and then comparing the extracted keywords with each item value of the metadata system.

However, when the identification information of the contents include a numeral or character string, it may be necessary to retain prepared data about the identification information of the contents of each electronic book with respect to a plurality of electronic books.

For example, it may be necessary to retain information on the whole elementary school textbooks which are being distributed by unit of content list or sub-list. It may be determined which content list or sub-list of the corresponding textbook the identification information of contents corresponds to, and then based thereon, a matching learning theme item may be selected from the metadata system.

Meanwhile, the learning asset storage unit 140 may store a plurality of learning assets, and the game contents storage unit 150 may store a plurality of game contents.

The concept of the learning asset may be identical to that described above, and each learning asset may include “learning theme” and “type” metadata items separately from its own data.

For example, the learning theme item value may include “number π”, and the type metadata value may include a value like “objective”.

Meanwhile, the concept of the game contents may be identical to that described above, and each game contents may include a “type” metadata item.

Meanwhile, the game executing unit 160 may execute the game in accordance with manipulation of a user. The game executing unit 160 may select game contents to be executed in the game, using the tracking result of the reading behavior of a user, and then may execute the game contents that are selected.

Hereinafter, a process of using the tracking result of the reading behavior of a user converted by the game executing unit 160 will be described in more detail.

When the learning theme item determined as significant in the reading process of a user is selected by the metadata converting unit 130, the game executing unit 160 may select a learning asset according to the selected learning theme item from a plurality of pre-stored learning assets.

For example, when the selected learning theme item is “number π”, a learning asset corresponding thereto may be selected.

Also, when the selected learning asset has type metadata “objective”, game contents according to the “objective” type may be selected from the plurality of game contents that are pre-stored.

Thereafter, the game executing unit 160 may execute the selected game contents. In this case, the game executing unit 160 may apply the learning assets to the game contents.

Meanwhile, the apparatus 100 of providing the game interworking with the electronic book may further include a game tracking unit for tracking the game play of a user.

The game tracking unit 170 may determine the skill change of a user with respect to a specific learning theme from the number of clears and the time spent for clear of the game contents to which the learning asset about a specific learning theme provided in the game is applied.

The learning asset provided through the game contents may correspond to a process of learning by repeating or practicing the knowledge or concept acquired during the reading process of the electronic book by a user, and it may be significant to track the degree of skillfulness about the same learning theme.

Meanwhile, when the clear time of the game contents to which the learning asset corresponding to a specific learning theme is applied is equal to or larger than an upper threshold value, i.e., when a user spends much time to clear the game contents, the game executing unit 160 may select a learning asset having lower difficulty as a learning asset corresponding to the same learning theme as the already selected learning asset.

Also, when the corresponding game contents are executed, a newly selected learning asset may be applied.

On the other hand, when the clear time of the game contents applied to the learning asset corresponding to a specific learning theme is equal to or less than a lower threshold value, i.e., when a user clicks the game contents in a very short time to clear the game, the game executing unit 161 may select a learning asset having higher difficulty as a learning asset corresponding to the same learning theme as the already selected learning asset. Thus, when the corresponding game contents are again executed, the newly selected learning asset may be applied.

Meanwhile, the game tracking unit 170 may generate the analysis result of the game play behavior of a user which includes the skill change of a user with respect to the specific learning theme, the difficulty adjustment of the learning asset corresponding to the specific learning theme, the skill change after the difficulty adjustment of the learning asset corresponding to the specific learning theme, and the reception of the learning contents related to the specific learning theme by the learning contents calling unit 123.

The electronic book communication unit 110 may return the analysis result of the game play behavior of a user to the electronic book. When the electronic book is a data form that is not independently executable even though the analysis result is expressed as returning to the electronic book, the analysis result may be returned to the viewer of the electronic book or other subjects for playing the electronic book.

Meanwhile, the metadata converting unit 130 may convert the analysis result of the game play behavior of a user into a format requested from the electronic book using the metadata system. In this case, the electronic book communication unit 110 may return the analysis result of the game play behavior of a user converted by the metadata converting unit 130 to the electronic book.

For example, when the viewer of the electronic book calls the game through API, the execution of the game is finished, and thus the analysis result of the game play behavior of a user may be returned as a return value of API. Also, the metadata converting unit 130 may perform conversion and return in accordance with the format of the API return value.

A value returned when a user plays the electronic book to resume the reading may be utilized.

If the viewer of the electronic book is configured to utilize past information tracked during the reading behavior of a user in next reading, the return value may be substituted with tracking information on the past reading behavior.

Meanwhile, a series of processes executed in the apparatus 100 of providing the game interworking with the electronic book according to the embodiments of the present invention can also be embodied as computer readable codes on a computer readable recording medium.

In this case, the computer readable recording medium is any data storage device that can store data which can be thereafter read by a computer system. Examples of the computer readable recording medium include DVD-read only memories (DVD-ROMs), CD-ROMs, hard disks, USB memories, and flash memories.

Meanwhile, the expression, ‘stored in a recording media’ does not compass only a case where contents are stored in recording media in mass quantity and distributed in a form of package, but also a case where contents are stored in recording media through a network in a form of data packet.

Although the term ‘network’ is used in this disclosure, the term should be construed as a broad concept compassing well-known wired/wireless communication methods such as Local Area Network (LAN) and Wide Area Network (WAN) depending on the distance and size, intranet and Virtual Private Network (VPN) depending on the characteristics of the connection route, and Wibro and WiFi depending on the connection method.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### Mode for Invention

### INDUSTRIAL APPLICABILITY

The present invention can be applied to the edutainment technology field.

1. An apparatus of providing a game interworking with an electronic book, the apparatus comprising a terminal device playing the electronic book to display the electronic book on a display device and playing the game to display on the display device in accordance with a user input through a user interface device, the apparatus comprising:
an electronic book communication unit receiving a tracking result of a reading behavior of a user acquired during the play of the electronic book from the electronic book;
a metadata storage unit storing a metadata system;
a metadata converting unit converting the tracking result of the reading behavior of a user received using the metadata system;
a game contents storage unit storing game contents; and
a game executing unit executing the game in accordance with manipulation of a user, selecting game contents to be executed in the game, using the tracking result of the reading behavior of a user, and executing the game contents that are selected,
wherein the metadata system stored in the metadata storage unit comprises a metadata item about a learning theme, and
the metadata converting unit selects a learning theme metadata item related to the electronic book that a user reads from the received tracking result of the reading behavior of a user.

2. The apparatus of claim 1, wherein the received tracking result of the reading behavior of a user comprises one or more pieces of information on type, frequency and duration time of an interaction of a user in regard to corresponding contents and identification information on contents included in the electronic book, and
the metadata converting unit selects identification information of one content, by multiplying the type, frequency, or duration time of the interaction of a user collected for each identification information of contents included in the electronic book by a certain weighted value and
selects a learning theme item related to the contents corresponding to the selected identification information from metadata.

3. The apparatus of claim 2, wherein the metadata converting unit assigns weighted values for each type of the interaction of a user, and selects identification information of contents in which a value obtained by multiplying the frequency of the interaction of a user by the weighted value or multiplying the duration time of interaction of a user by the weighted value is determined as the largest.

4. The apparatus of claim 2, further comprising a learning asset storage unit storing a plurality of learning assets,
wherein:
the learning asset is for repeated learning of a learning theme and comprises a plurality of elements applicable to game contents;
the game contents are template type of contents in which the learning asset is reflected to be executed;
the metadata system further comprises a type item of the game contents or the learning asset; and
the game executing unit selects a learning asset according to the selected learning theme item from a plurality of pre-stored learning assets,
selects game contents according to the type of the selected learning asset, and
executes the selected game contents by applying the learning assets to the game contents.

5. The apparatus of claim 2, further comprising a game tracking unit for tracking the game play of a user,
wherein the game tracking unit determines a skill change of a user with respect to a specific learning theme from the number of clears or the time spent for clear of game contents to which a learning asset about a specific learning theme provided in the game is applied.

6. The apparatus of claim 5, wherein as the tracking result by the game tracking unit, when the clear time of the game contents to which the learning asset corresponding to a specific learning theme is applied is determined as equal to or larger than an upper threshold value, the game executing unit selects a learning asset having lower difficulty as a learning asset corresponding to the same learning theme as the already selected learning asset, and
when the clear time of the game contents to which the learning asset corresponding to a specific learning theme is applied is determined as equal to or less than a lower threshold value, the game executing unit selects a learning asset having higher difficulty as a learning asset corresponding to the same learning theme as the already selected learning asset,
applying the learning asset when the game contents are again executed.

7. The apparatus of claim 5, wherein the game tracking unit generates an analysis result of the game play behavior of a user which comprises one or more pieces of information of the skill change of a user with respect to the specific learning theme, the difficulty adjustment of the learning asset corresponding to the specific learning theme, the skill change after the difficulty adjustment of the learning asset corresponding to the specific learning theme, and the reception of the learning contents related to the specific learning theme by a learning contents calling unit, and
the electronic book communication unit returns the analysis result of the game play behavior of a user to the electronic book.

8. The apparatus of claim 7, wherein the metadata converting unit converts the analysis result of the game play behavior of a user into a format requested from the electronic book using the metadata system, and
the electronic book communication unit returns the analysis result of the game play behavior of a user converted by the metadata converting unit to the electronic book.
